(19) United States
(12) Patent Application Publication
(10) Pub. No.: US 2025/0178144 A1
(43) Pub. Date: Jun. 5, 2025

(54) Coolant Supply Device

(71) Applicant: DMG MORI CO., LTD., Nara (JP)

(72) Inventor: Genki FUNAKOSHI, NARA (JP)

(73) Assignee: DMG MORI CO., LTD., Nara (JP)

(21) Appl. No.: 18/844,837

(22) PCT Filed: Mar. 3, 2023
(86) PCT No.: PCT/JP2023/008028

§ 371 Date: Sep. 6, 2024

(30) Foreign Application Priority Data
Mar. 10, 2022 (JP) 2022-037089

(51) Int. Cl. B23Q 11/10

(52) U.S. Cl. CPC B23Q 11/10

(57) ABSTRACT

A coolant supply device includes: a first coolant tank; a first pump that (86), delivers a coolant from the first coolant tank using a first pressure-feeding mechanism portion; a second pump that (86) (87) (21), delivers the coolant from the first coolant tank using a second pressure-feeding mechanism portion, and a screw immersed in the coolant stored in the first coolant tank; a first flow path through which the coolant from the first pump flows; a second flow path through which the coolant from the second pump flows; and a first foreign matter capturing unit that has a filtration filter, and is provided on a route of the first flow path. The coolant having passed through the first foreign matter capturing unit flows directly through a separately placed coolant tank without passing through a machining area of a machine tool.

### TECHNICAL FIELD

The present invention relates to a coolant supply device.

### BACKGROUND ART

For example, Japanese Patent Laying-Open No. 2020-69540 (PTL 1) discloses a coolant supply device including a primary tank that stores a coolant, a secondary tank to which the coolant pumped up out of the primary tank is transferred, first and second filters that separate chips from the coolant delivered from the primary tank to the secondary tank, and a filter that removes relatively large chips from the coolant collected from a machine tool to the primary tank.

### CITATION LIST

### Patent Literature

PTL 1: Japanese Patent Laying-Open No. 2020-69540.

### SUMMARY OF INVENTION

### Technical Problem

As disclosed in PTL 1 above, there is known a coolant supply device for supplying a coolant to a machining area of a workpiece, wherein a foreign matter capturing unit for capturing a foreign matter such as chips or sludge is provided on a flow path of the coolant. Examples of such a foreign matter capturing unit include a filter-type foreign matter capturing unit that captures a foreign matter using a net-like filtration filter, and a filterless-type foreign matter capturing unit that captures a foreign matter using the centrifugal force, the magnetic force or the like without using a filtration filter.

In the filter-type foreign matter capturing unit, of these foreign matter capturing units, the efficiency of capturing of the foreign matter decreases when the filtration filter is clogged. Therefore, an operator needs to replace or clean the filtration filter in a timely manner. However, depending on the arrangement of the foreign matter capturing unit in the coolant supply device, the filtration filter may be clogged in a short time. In this case, an excessive burden occurs in maintenance of the foreign matter capturing unit.

Accordingly, an object of the present invention is to solve the above-described problem and provide a coolant supply device in which a burden of maintenance of a foreign matter capturing unit can be kept small.

### Solution to Problem

A coolant supply device according to an aspect of the present invention includes: a first coolant tank that stores a coolant; a first pump that has a first pressure-feeding mechanism portion capable of pressure-feeding the coolant, and delivers the coolant from the first coolant tank using the first pressure-feeding mechanism portion; a second pump that has a second pressure-feeding mechanism portion capable of pressure-feeding the coolant and a screw immersed in the coolant stored in the first coolant tank, and delivers the coolant from the first coolant tank using the second pressure-feeding mechanism portion and the screw; a first flow path through which the coolant from the first pump flows; a second flow path through which the coolant from the second pump flows; and a first foreign matter capturing unit that has a filtration filter, captures a foreign matter contained in the coolant using the filtration filter, and is provided on a route of the first flow path, of the first flow path and the second flow path. The coolant having passed through the first foreign matter capturing unit flows directly through the first coolant tank or a separately placed coolant tank without passing through a machining area of a machine tool.

A coolant supply device according to another aspect of the present invention includes: a first coolant tank that stores a coolant; a first pump that has a first pressure-feeding mechanism portion capable of pressure-feeding the coolant, and delivers the coolant from the first coolant tank using the first pressure-feeding mechanism portion; a second pump that has a second pressure-feeding mechanism portion capable of pressure-feeding the coolant and a screw immersed in the coolant stored in the first coolant tank, and delivers the coolant from the first coolant tank using the second pressure-feeding mechanism portion and the screw; a first flow path through which the coolant from the first pump flows; a second flow path through which the coolant from the second pump flows; and a first foreign matter capturing unit that has a filtration filter, captures a foreign matter contained in the coolant using the filtration filter, and is provided on a route of the first flow path, of the first flow path and the second flow path.

According to the coolant supply device configured as described above, the first pump has the first pressure-feeding mechanism portion, and the second pump has the screw in addition to the second pressure-feeding mechanism portion. Therefore, the foreign matter contained in the coolant stored in the first coolant tank is stirred more greatly when the second pump is driven, as compared with when the first pump is driven. In this case, an amount of the foreign matter collected from the first coolant tank to the second pump is larger than an amount of the foreign matter collected from the first coolant tank to the first pump. In such a configuration, by providing the first foreign matter capturing unit having the filtration filter on the route of the first flow path, of the first flow path through which the coolant from the first pump flows and the second flow path through which the coolant from the second pump flows, the timing of clogging of the filtration filter can be delayed. As a result, a burden of maintenance of the first foreign matter capturing unit can be kept small.

In addition, preferably, the coolant supply device further includes a second foreign matter capturing unit that is of filterless type, captures the foreign matter contained in the coolant, and is provided on a route of the second flow path.

According to the coolant supply device configured as described above, even when the coolant delivered by the second pump and flowing through the second flow path contains a large amount of the foreign matter, the occurrence of an excessive burden in maintenance of the second foreign matter capturing unit can be avoided because the second foreign matter capturing unit disposed on the route of the second flow path is of filterless type.

In addition, preferably, the second foreign matter capturing unit is a magnet separator that captures the foreign matter using magnetic force, or a cyclone separator or a centrifugal separator that captures the foreign matter using centrifugal force.

According to the coolant supply device configured as described above, even when the coolant flowing through the second flow path contains a large amount of the foreign matter, the occurrence of an excessive burden in maintenance of the magnet separator, the cyclone separator or the centrifugal separator can be avoided.

In addition, preferably, the second flow path forms a circulation path for the coolant starting from the first coolant tank.

According to the coolant supply device configured as described above, a cycle of collecting the foreign matter from the first coolant tank to the second pump and capturing the foreign matter by the second foreign matter capturing unit, and then, returning, to the first coolant tank, the coolant from which the foreign matter has been removed is repeated. As a result, the coolant stored in the first coolant tank can be cleaned.

In addition, preferably, the coolant supply device further includes a first coolant discharge portion that is supplied with the coolant through the second flow path, and discharges the coolant to avoid a machining point of a workpiece in the machining area.

According to the coolant supply device configured as described above, even when the coolant flowing through the second flow path contains a large amount of the foreign matter, the first coolant discharge portion supplied with the coolant through the second flow path can sufficiently offer the performance required for discharge of the coolant by the first coolant discharge portion because the first coolant discharge portion discharges the coolant to avoid the machining point of the workpiece in the machining area.

In addition, preferably, the coolant supply device further includes: a second coolant tank that stores the coolant discharged from inside the machining area; a third pump that delivers the coolant from the second coolant tank; a third flow path through which the coolant from the third pump flows, the third flow path returning the coolant to the first coolant tank; and a third foreign matter capturing unit that captures the foreign matter contained in the coolant, and is provided on a route of the third flow path.

According to the coolant supply device configured as described above, the foreign matter is captured by the third foreign matter capturing unit, and the coolant from which the foreign matter has been removed is returned to the first coolant tank. As a result, the clean coolant can be stored in the first coolant tank.

In addition, preferably, the coolant supply device further includes a second coolant discharge portion that is supplied with the coolant through the first flow path, and discharges the coolant toward a machining point of a workpiece in the machining area.

According to the coolant supply device configured as described above, the foreign matter is captured by the first foreign matter capturing unit, and the coolant from which the foreign matter has been removed is supplied to the second coolant discharge portion. As a result, the clean coolant is discharged toward the machining point of the workpiece in the machining area, and thus, a decrease in workpiece machining accuracy caused by the presence of the foreign matter at the machining point of the workpiece can be prevented.

In addition, preferably, the first pump has a first suction portion that is immersed in the coolant stored in the first coolant tank, and suctions the coolant. The second pump has a second suction portion that is immersed in the coolant stored in the first coolant tank, and suctions the coolant. A distance from a bottom portion of the first coolant tank to the first suction portion is greater than a distance from the bottom portion of the first coolant tank to the second suction portion.

According to the coolant supply device configured as described above, since the distance between the bottom portion of the first coolant tank on which the foreign matter precipitates and the first suction portion is relatively great, collection of the foreign matter from the first coolant tank to the first pump can be suppressed. As a result, the timing of clogging of the filtration filter can be further delayed.

### Advantageous Effects of Invention

As described above, according to the present invention, it is possible to provide a coolant supply device in which a burden of maintenance of a foreign matter capturing unit can be kept small.

### BRIEF DESCRIPTION OF DRAWINGS

FIG. 1 is a system diagram showing a coolant supply device according to a first embodiment of the present invention.

FIG. 2 is a cross-sectional view showing a second pump in FIG. 1.

FIG. 3 is a perspective view showing the second pump in a range surrounded by a dash-dot-dot line III in FIG. 2.

FIG. 4 is a cross-sectional view showing a first pump in FIG. 1.

FIG. 5 is a system diagram showing a coolant treatment device according to a second embodiment of the present invention.

### DESCRIPTION OF EMBODIMENTS

Embodiments of the present invention will be described with reference to the drawings. In the drawings referenced below, the same or corresponding members are denoted by the same numerals.

### First Embodiment

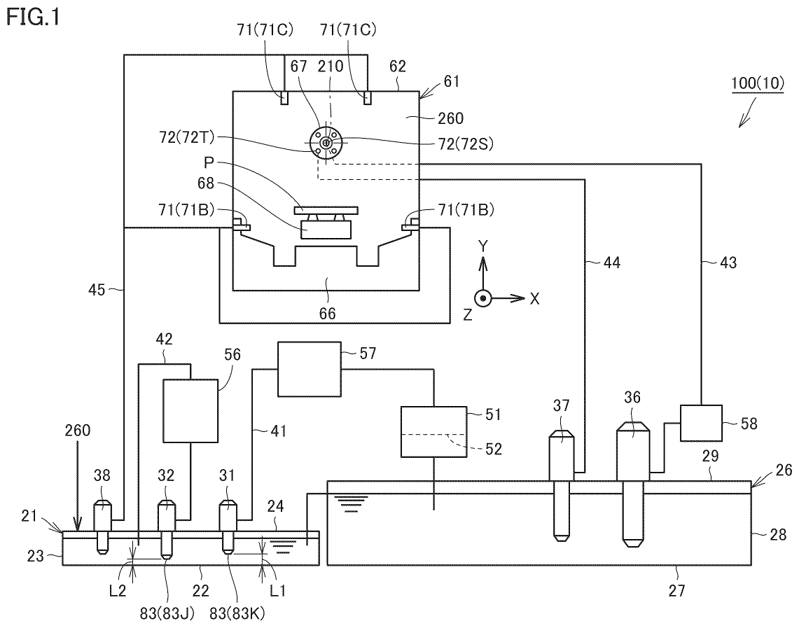

FIG. 1 is a system diagram showing a coolant supply device according to a first embodiment of the present invention.

Referring to FIG. 1, a coolant supply device 100 according to the present embodiment is applied to a machine tool 10. Machine tool 10 is a machining center that performs workpiece machining by bringing a workpiece into contact with a rotating tool. FIG. 1 shows a Z axis parallel to the horizontal direction and parallel to a rotation central axis of a tool, an X axis parallel to the horizontal direction and orthogonal to the rotation central axis of the tool, and a Y axis parallel to the vertical direction.

The machine tool to which the coolant treatment device according to the present invention is applied is not limited to the machining center, and may be a lathe that performs workpiece machining by bringing a rotating workpiece into contact with a tool, or may be a composite machining machine having the turning function and the milling function or an AM/SM hybrid machining machine that can perform additive manufacturing (AM) machining of a workpiece and subtractive manufacturing (SM) machining of a workpiece.

Machine tool 10 has a bed 66, a tool spindle 67, a table 68, and a cover body 61.

Bed 66 is a base member for supporting tool spindle 67, table 68 and the like, and is placed on a floor surface of a factory or the like. Bed 66 is made of cast metal.

Tool spindle 67 causes a tool such as a drill, a reamer or a milling cutter to rotate about a rotation central axis 210 extending in the Z-axis direction. A clamp mechanism for detachably holding the tool is built into tool spindle 67. Tool spindle 67 is supported on bed 66 by a not-shown column or the like. Tool spindle 67 is provided to be movable in the X-axis direction and the Y-axis direction by various types of feeding mechanisms, guide mechanisms, servo motors or the like provided in the column or the like.

Table 68 is a device for fixing a workpiece. A pallet P is detachably attached to table 68. The workpiece is attached to pallet P through a jig such as an equerre. Table 68 is provided to be movable in the Z-axis direction by various types of feeding mechanisms, guide mechanisms, servo motors or the like provided in bed 66 or the like.

The workpiece made of ceramic is attached to pallet P. A workpiece made of iron may be attached to pallet P, or a workpiece made of glass may be attached to pallet P. The workpiece may be a magnetic member, or may be a non-magnetic member.

Cover body 61 defines a machining area 260 and forms an external appearance of machine tool 10. Machining area 260 is a space where workpiece machining is performed, and is sealed to prevent chips, a coolant or the like caused by workpiece machining to leak to the outside of machining area 260. Tool spindle 67, table 68 and the like are disposed in machining area 260.

Coolant supply device 100 is a device for supplying, toward machining area 260, the coolant used for workpiece machining. The coolant discharged from machining area 260 as a result of workpiece machining is guided to and stored in coolant supply device 100. Coolant supply device 100 cleans the coolant from machining area 260 and supplies the clean coolant to machining area 260 again.

Coolant supply device 100 has a machine-side coolant tank 21 and a separately placed coolant tank 26. Machine-side coolant tank 21 and separately placed coolant tank 26 are separate tanks. Machine-side coolant tank 21 and separately placed coolant tank 26 are provided along with bed 66.

Machine-side coolant tank 21 is configured to be capable of storing the coolant. Machine-side coolant tank 21 has a bottom portion 22, a side portion 23 and a top portion 24. Bottom portion 22 is disposed at the bottom of machine-side coolant tank 21. Side portion 23 rises from a peripheral edge of bottom portion 22. A space that can store the coolant is formed at a position above bottom portion 22 and surrounded by side portion 23. Top portion 24 is disposed to face bottom portion 22 in an up-down direction.

Separately placed coolant tank 26 is configured to be capable of storing the coolant. Separately placed coolant tank 26 has a bottom portion 27, a side portion 28 and a top portion 29. Bottom portion 27, side portion 28 and top portion 29 correspond to bottom portion 22, side portion 23 and top portion 24 of machine-side coolant tank 21, respectively.

Machine-side coolant tank 21 stores the coolant discharged from machining area 260. Separately placed coolant tank 26 stores the coolant transferred from machine-side coolant tank 21. The coolant stored in machine-side coolant tank 21 and separately placed coolant tank 26 is supplied toward machining area 260.

Coolant supply device 100 further has a first pump 31, a first flow path 41, a second pump 32, a second flow path 42, a first foreign matter capturing unit 51, a second foreign matter capturing unit 56, and a fourth foreign matter capturing unit 57.

First pump 31 is provided in machine-side coolant tank 21. First pump 31 is attached to top portion 24. First pump 31 is an immersion-type pump in which at least a part of a below-described pump portion 81 is immersed in the coolant stored in machine-side coolant tank 21. First pump 31 delivers the coolant from machine-side coolant tank 21.

First flow path 41 is a passage through which the coolant flows, and is formed of a pipe member such as a steel pipe or a hose. The coolant from first pump 31 flows through first flow path 41. First flow path 41 extends between first pump 31 and separately placed coolant tank 26. When first pump 31 is driven, a coolant flow from machine-side coolant tank 21 through first flow path 41 to separately placed coolant tank 26 is formed.

Second pump 32 is provided in machine-side coolant tank 21. Second pump 32 is attached to top portion 24. Second pump 32 is an immersion-type pump in which at least a part of below-described pump portion 81 is immersed in the coolant stored in machine-side coolant tank 21. Second pump 32 delivers the coolant from machine-side coolant tank 21.

Second flow path 42 is a passage through which the coolant flows, and is formed of a pipe member such as a steel pipe or a hose. The coolant from second pump 32 flows through second flow path 42. Second flow path 42 forms a circulation path for the coolant starting from machine-side coolant tank 21. When second pump 32 is driven, a coolant flow from machine-side coolant tank 21 through second flow path 42 again to machine-side coolant tank 21 is formed.

First foreign matter capturing unit 51 is provided on a route of first flow path 41, of first flow path 41 and second flow path 42. First foreign matter capturing unit 51 is provided on the route of first flow path 41, not on a route of second flow path 42. First foreign matter capturing unit 51 is not provided on the route of second flow path 42. First foreign matter capturing unit 51 is provided more downstream of the coolant flow formed in first flow path 41 than first pump 31.

First foreign matter capturing unit 51 has a filtration filter 52. Filtration filter 52 is formed of a net-like mesh body in which fine holes are arranged. Filtration filter 52 is detachably attached to a main body of first foreign matter capturing unit 51. First foreign matter capturing unit 51 captures a foreign matter such as chips or sludge contained in the coolant flowing through first flow path 41, using filtration filter 52. More specifically, the coolant flowing through first flow path 41 passes through filtration filter 52. At this time, a foreign matter that is smaller than the mesh of filtration filter 52 cannot pass through filtration filter 52, and thus, is separated from the coolant.

Second foreign matter capturing unit 56 is provided on the route of second flow path 42. Second foreign matter capturing unit 56 is provided more downstream of the coolant flow formed in second flow path 42 than second pump 32.

Second foreign matter capturing unit 56 captures a foreign matter such as chips or sludge contained in the coolant flowing through second flow path 42. Second foreign matter capturing unit 56 is a filterless-type foreign matter capturing unit that does not have a filtration filter. Second foreign matter capturing unit 56 is a cyclone separator that captures a foreign matter using the centrifugal force. More specifically, the coolant introduced into second foreign matter capturing unit 56 flows through a downwardly tapering conical space along a circumferential direction thereof. During this time, the foreign matter contained in the coolant is gathered on a circumferential wall portion of the conical space due to the centrifugal force, and sinks downward while moving in the circumferential direction, and is separated from the coolant.

The type of second foreign matter capturing unit 56 is not particularly limited as long as second foreign matter capturing unit 56 is of filterless type. Second foreign matter capturing unit 56 may be a centrifugal separator that captures a foreign matter using the centrifugal force similarly to the cyclone separator and is larger in size than the cyclone separator. When a machining target in machining area 260 is a workpiece made of iron, second foreign matter capturing unit 56 may be a magnet separator that captures a foreign matter using the magnetic force.

A size of fine particles that can be captured by first foreign matter capturing unit 51 is smaller than a size of fine particles that can be captured by second foreign matter capturing unit 56. As one example, the size of fine particles that can be captured by first foreign matter capturing unit 51 is 1 μm and the size of fine particles that can be captured by second foreign matter capturing unit 56 is 10 μm.

Fourth foreign matter capturing unit 57 is provided on a route of first flow path 41. Fourth foreign matter capturing unit 57 is provided more downstream of the coolant flow formed in first flow path 41 than first pump 31. Fourth foreign matter capturing unit 57 is provided more upstream of the coolant flow formed in first flow path 41 than first foreign matter capturing unit 51.

Fourth foreign matter capturing unit 57 captures a foreign matter such as chips or sludge contained in the coolant flowing through first flow path 41. Fourth foreign matter capturing unit 57 is a filterless-type foreign matter capturing unit that does not have a filtration filter. Fourth foreign matter capturing unit 57 is a cyclone separator that captures a foreign matter using the centrifugal force.

The size of fine particles that can be captured by first foreign matter capturing unit 51 is smaller than a size of fine particles that can be captured by fourth foreign matter capturing unit 57. As one example, the size of fine particles that can be captured by first foreign matter capturing unit 51 is 1 μm and the size of fine particles that can be captured by fourth foreign matter capturing unit 57 is 10 μm.

Coolant supply device 100 further has a first coolant discharge portion 71 and a second coolant discharge portion 72.

First coolant discharge portion 71 discharges the coolant to avoid a machining point of the workpiece in machining area 260. The machining point of the workpiece refers to a contact point between the workpiece and the tool.

More specifically, coolant supply device 100 has, as first coolant discharge portion 71, a base coolant discharge portion 71B and a shower coolant discharge portion 71C.

Base coolant discharge portion 71B is attached to bed 66. The coolant supply from base coolant discharge portion 71B is mainly intended to supply the coolant to a wall surface of bed 66 and thereby discharge chips generated as a result of workpiece machining from inside machining area 260. Shower coolant discharge portion 71C is attached to a ceiling portion 62 of cover body 61. The coolant supply from shower coolant discharge portion 71C is mainly intended to supply the coolant from ceiling portion 62 to the whole of machining area 260 and thereby discharge chips generated as a result of workpiece machining from inside machining area 260.

Second coolant discharge portion 72 discharges the coolant toward the machining point of the workpiece in machining area 260.

More specifically, coolant supply device 100 has, as second coolant discharge portion 72, a spindle-through coolant discharge portion 72S and a spindle coolant discharge portion 72T.

Spindle-through coolant discharge portion 72S and spindle coolant discharge portion 72T are provided in tool spindle 67. Spindle-through coolant discharge portion 72S discharges the coolant from a cutting edge of the tool held by tool spindle 67 through a spindle of tool spindle 67. Spindle coolant discharge portion 72T discharges the coolant from a spindle end face through a housing of tool spindle 67. The coolant supply from spindle-through coolant discharge portion 72S and spindle coolant discharge portion 72T is mainly intended to supply the coolant to the machining point of the workpiece and thereby suppress heat generation at the machining point of the workpiece and/or achieve lubrication between the workpiece and the tool.

Coolant supply device 100 further has a spindle-through pump 36, a spindle pump 37, a shower/base pump 38, a spindle-through flow path 43, a spindle flow path 44, and a shower/base flow path 45.

Spindle-through pump 36 is provided in separately placed coolant tank 26. Spindle-through pump 36 is attached to top portion 29. Spindle-through pump 36 is an immersion-type pump. Spindle-through pump 36 delivers the coolant from separately placed coolant tank 26.

Spindle-through flow path 43 is a passage through which the coolant flows, and is formed of a pipe member such as a steel pipe or a hose. The coolant from spindle-through pump 36 flows through spindle-through flow path 43. Spindle-through flow path 43 extends between spindle-through pump 36 and tool spindle 67. When spindle-through pump 36 is driven, a coolant flow from separately placed coolant tank 26 through spindle-through flow path 43 and tool spindle 67 to spindle-through coolant discharge portion 72S is formed.

An inline-type pump 58 that delivers the coolant toward spindle-through coolant discharge portion 72S is further provided on a route of spindle-through flow path 43.

Spindle pump 37 is provided in separately placed coolant tank 26. Spindle pump 37 is attached to top portion 29. Spindle pump 37 is an immersion-type pump. Spindle pump 37 delivers the coolant from separately placed coolant tank 26.

Spindle flow path 44 is a passage through which the coolant flows, and is formed of a pipe member such as a steel pipe or a hose. The coolant from spindle pump 37 flows through spindle flow path 44. Spindle flow path 44 extends between spindle pump 37 and tool spindle 67. When spindle pump 37 is driven, a coolant flow from separately placed coolant tank 26 through spindle flow path 44 and tool spindle 67 to spindle coolant discharge portion 72T is formed.

Shower/base pump 38 is provided in machine-side coolant tank 21. Shower/base pump 38 is attached to top portion 24. Shower/base pump 38 is an immersion-type pump. Shower/base pump 38 delivers the coolant from machine-side coolant tank 21.

Shower/base flow path 45 is a passage through which the coolant flows, and is formed of a pipe member such as a steel pipe or a hose. The coolant from shower/base pump 38 flows through shower/base flow path 45. Shower/base flow path 45 extends between shower/base pump 38 and base and shower coolant discharge portions 71B and 71C. When shower/base pump 38 is driven, a coolant flow from machine-side coolant tank 21 through shower/base flow path 45 to base coolant discharge portion 71B and shower coolant discharge portion 71C is formed.

A pump for supplying the coolant to base coolant discharge portion 71B and a pump for supplying the coolant to shower coolant discharge portion 71C may be provided separately.

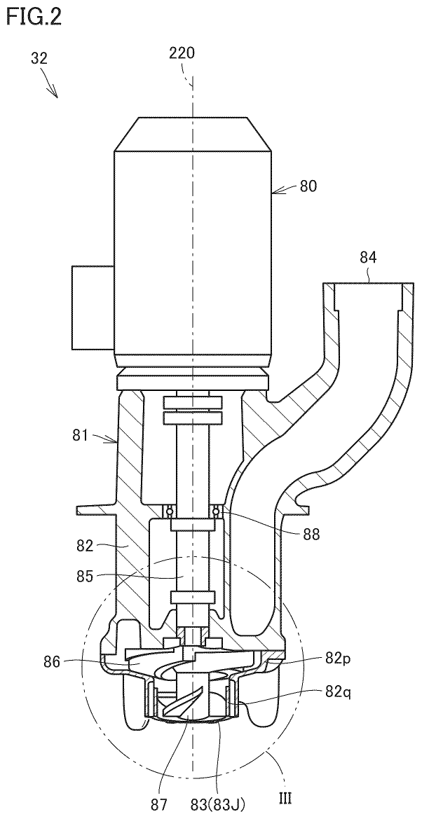

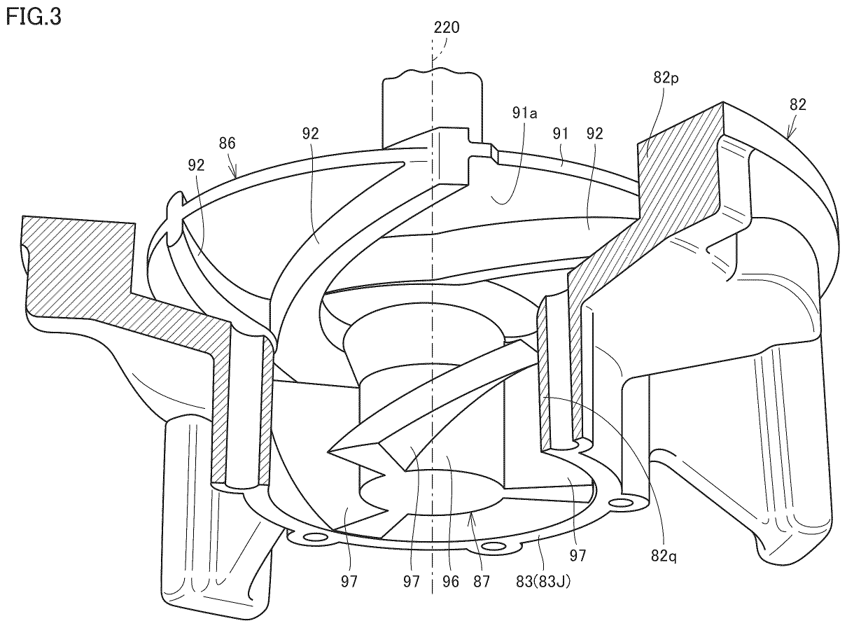

FIG. 2 is a cross-sectional view showing the second pump in FIG. 1. FIG. 3 is a perspective view showing the second pump in a range surrounded by a dash-dot-dot line III in FIG. 2.

Referring to FIGS. 1 to 3, second pump 32 has a motor portion 80 and pump portion 81.

Motor portion 80 and pump portion 81 are provided to line up on an axis of a central axis 220 extending in the vertical direction. Motor portion 80 is disposed above top portion 24 of machine-side coolant tank 21. An upper part of pump portion 81 is disposed above top portion 24 of machine-side coolant tank 21, and a lower part of pump portion 81 is disposed below top portion 24 of machine-side coolant tank 21.

Motor portion 80 is provided as a power source for second pump 32. Motor portion 80 is supplied with electric power and thereby outputs the rotational motion about central axis 220. Pump portion 81 is driven in response to the rotational motion from motor portion 80, and delivers the coolant.

Pump portion 81 has a housing 82, a shaft 85, an impeller 86, and a screw 87.

Housing 82 forms an external appearance of pump portion 81. Housing 82 as a whole has a tubular shape extending along the axial direction of central axis 220.

Housing 82 has a suction portion 83 and a discharge portion 84. Suction portion 83 is provided at a lower end of housing 82. Suction portion 83 is open downward on the axis of central axis 220. Suction portion 83 is open to face bottom portion 22 of machine-side coolant tank 21 in the up-down direction. Suction portion 83 is immersed in the coolant stored in machine-side coolant tank 21. Discharge portion 84 is open at a position that is distant radially outward from central axis 220. Discharge portion 84 is open at a position above top portion 24 of machine-side coolant tank 21. A pipe that forms second flow path 42 and extends toward second foreign matter capturing unit 56 is connected to discharge portion 84.

Shaft 85 is housed in housing 82. Shaft 85 extends on the axis of central axis 220. Shaft 85 is supported by a bearing 88 so as to be rotatable about central axis 220. An upper end of shaft 85 is connected to an output shaft of motor portion 80.

Impeller 86 and screw 87 are housed in housing 82. Impeller 86 and screw 87 are connected to a lower end of shaft 85. Shaft 85 transmits the rotational motion output from motor portion 80 to impeller 86 and screw 87. Impeller 86 and screw 87 rotate about central axis 220 integrally with shaft 85.

Impeller 86 is disposed between motor portion 80 and screw 87 in the axial direction of central axis 220. Screw 87 is disposed between impeller 86 and suction portion 83 in the axial direction of central axis 220. A length between screw 87 and suction portion 83 in the axial direction of central axis 220 is shorter than a length between impeller 86 and suction portion 83 in the axial direction of central axis 220. Screw 87 faces bottom portion 22 of machine-side coolant tank 21 through the opening of suction portion 83.

Impeller 86 and screw 87 are formed of a vane wheel disposed around central axis 220. A diameter of impeller 86 is larger than a diameter of screw 87. A length of impeller 86 in the axial direction of central axis 220 is shorter than a length of screw 87 in the axial direction of central axis 220.

As shown in FIG. 3, impeller 86 is provided as a pressure-feeding mechanism portion for pressure-feeding the coolant. Impeller 86 has a disc portion 91 and a plurality of first vane portions 92.

Disc portion 91 has such a disc shape that the axial direction of central axis 220 is a thickness direction. Disc portion 91 has a disc surface 91a. Disc surface 91a faces downward. Disc surface 91a faces bottom portion 22 of machine-side coolant tank 21 in the axial direction of central axis 220. Each of first vane portions 92 has a rib shape protruding from disc surface 91a. Each of first vane portions 92 extends from the radially inner side to the radially outer side of central axis 220 while shifting in the circumferential direction of central axis 220. The plurality of first vane portions 92 are spaced apart from each other in the circumferential direction of central axis 220.

Screw 87 has a shaft portion 96 and a plurality of second vane portions 97. Shaft portion 96 extends on the axis of central axis 220. Shaft portion 96 protrudes from disc surface 91a. A diameter of shaft portion 96 is smaller than a diameter of disc portion 91. Each of second vane portions 97 has a rib shape protruding from an outer circumferential surface of shaft portion 96. Each of second vane portions 97 extends in the axial direction of central axis 220 while shifting in the circumferential direction of central axis 220.

Housing 82 further has an enlarged-diameter portion 82p and a reduced-diameter portion 82q. Enlarged-diameter portion 82p has a cylindrical shape centered on central axis 220. A space inside enlarged-diameter portion 82p communicates with discharge portion 84. Impeller 86 is disposed in the space inside enlarged-diameter portion 82p. Reduced-diameter portion 82q has a cylindrical shape centered on central axis 220. Reduced-diameter portion 82q has a diameter (inner diameter) smaller than that of enlarged-diameter portion 82p. Reduced-diameter portion 82q is connected to a lower end of enlarged-diameter portion 82p. A lower end of reduced-diameter portion 82q forms suction portion 83. Screw 87 is disposed in a space inside reduced-diameter portion 82q. In the axial direction of central axis 220, a lower end of screw 87 is aligned with an opening surface formed by suction portion 83.

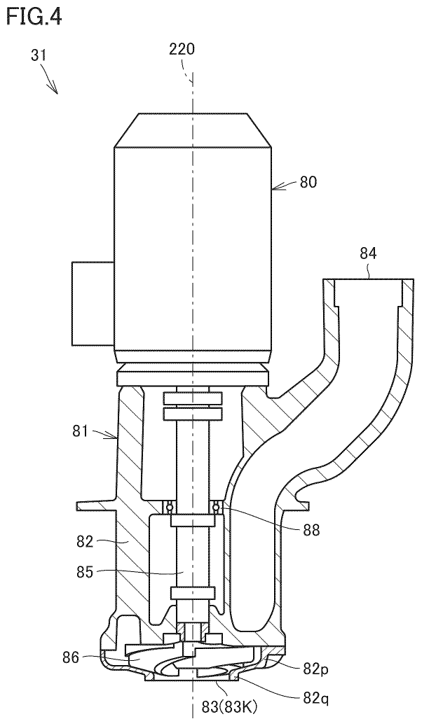

FIG. 4 is a cross-sectional view showing the first pump in FIG. 1. Referring to FIG. 4, although first pump 31 has basically the same structure as that of second pump 32, first pump 31 does not have screw 87. Only impeller 86 is connected to the lower end of shaft 85. Shaft 85 transmits the rotational motion output from motor portion 80 to impeller 86. Impeller 86 rotates about central axis 220 integrally with shaft 85.

Housing 82 has such a shape that reduced-diameter portion 82q is reduced by a length, in the axial direction of central axis 220, of the space where screw 87 is disposed in second pump 32 in FIGS. 2 and 3. Impeller 86 faces bottom portion 22 of machine-side coolant tank 21 through the opening of suction portion 83.

Referring to FIGS. 1 to 4, when first pump 31 is driven, impeller 86 rotates about central axis 220, whereby the coolant is suctioned into housing 82 through suction portion 83. The coolant suctioned into housing 82 is delivered radially outward of central axis 220 by the plurality of first vane portions 92 in the space inside enlarged-diameter portion 82p. The coolant delivered by the plurality of first vane portions 92 is discharged to first flow path 41 through discharge portion 84.

When second pump 32 is driven, impeller 86 and screw 87 rotate about central axis 220, whereby the coolant is suctioned into housing 82 through suction portion 83. The coolant suctioned into housing 82 is delivered in the axial direction of central axis 220 by the plurality of second vane portions 97 in the space inside reduced-diameter portion 82q, and further, is delivered radially outward of central axis 220 by the plurality of first vane portions 92 in the space inside enlarged-diameter portion 82p. The coolant delivered by the plurality of first vane portions 92 is discharged to second flow path 42 through discharge portion 84.

First pump 31 has impeller 86, and second pump 32 has screw 87 in addition to impeller 86. Therefore, the coolant suction force by second pump 32 is greater than the coolant suction force by first pump 31. In this case, the coolant stored in machine-side coolant tank 21 is stirred more greatly when second pump 32 is driven, as compared with when first pump 31 is driven, and a large amount of a foreign matter is stirred up from bottom portion 22. As a result, an amount of the foreign matter collected from machine-side coolant tank 21 to second pump 32 is larger than an amount of the foreign matter collected from machine-side coolant tank 21 to first pump 31.

In such a configuration, first foreign matter capturing unit 51 having filtration filter 52 is provided on the route of first flow path 41 through which the coolant from first pump 31 flows, and second foreign matter capturing unit 56 of filterless type is provided on the route of second flow path 42 through which the coolant from second pump 32 flows. Therefore, in first foreign matter capturing unit 51, the amount of the foreign matter collected from machine-side coolant tank 21 to first pump 31 is relatively small, and thus, the timing of clogging of filtration filter 52 can be delayed. As a result, a burden of maintenance of first foreign matter capturing unit 51 can be kept small. In addition, although the amount of the foreign matter collected from machine-side coolant tank 21 to second pump 32 is relatively large, the occurrence of an excessive burden in maintenance of second foreign matter capturing unit 56 can be avoided because second foreign matter capturing unit 56 is of filterless type.

In addition, second flow path 42 through which the coolant from second pump 32 flows forms the circulation path for the coolant starting from machine-side coolant tank 21. With such a configuration, a cycle of collecting the foreign matter from machine-side coolant tank 21 to second pump 32 and capturing the foreign matter by second foreign matter capturing unit 56, and then, returning, to machine-side coolant tank 21, the coolant from which the foreign matter has been removed is repeated. As a result, the coolant stored in machine-side coolant tank 21 can be cleaned.

In addition, the foreign matter is collected from machine-side coolant tank 21 to first pump 31 and is captured by fourth foreign matter capturing unit 57 and first foreign matter capturing unit 51 provided on the route of first flow path 41, and then, the coolant from which the foreign matter has been removed is supplied to separately placed coolant tank 26. The coolant stored in separately placed coolant tank 26 is supplied to second coolant discharge portion 72 (spindle-through coolant discharge portion 72S and spindle coolant discharge portion 72T) through spindle-through flow path 43 and spindle flow path 44.

In this way, the coolant stored in machine-side coolant tank 21 is supplied to second coolant discharge portion 72 through first flow path 41. As a result, the clean coolant is supplied to the machining point of the workpiece, and thus, a decrease in workpiece machining accuracy caused by the presence of the foreign matter at the machining point of the workpiece can be prevented.

As shown in FIG. 1, first pump 31 has a first suction portion 83K as suction portion 83. Second pump 32 has a second suction portion 83J as suction portion 83. A distance L1 from bottom portion 22 of machine-side coolant tank 21 to first suction portion 83K is greater than a distance L2 from bottom portion 22 of machine-side coolant tank 21 to second suction portion 83J (L1>L2).

The foreign matter precipitates on bottom portion 22 of machine-side coolant tank 21. In this case, when a positional relationship of first suction portion 83K and second suction portion 83J with respect to bottom portion 22 of machine-side coolant tank 21 satisfies L1>L2, collection of the foreign matter from machine-side coolant tank 21 to first pump 31 can be suppressed. As a result, the timing of clogging of filtration filter 52 can be further delayed.

The structure of coolant supply device 100 according to the first embodiment of the present invention as described above will be summarized. Coolant supply device 100 according to the present embodiment includes: machine-side coolant tank 21 as a first coolant tank that stores a coolant; first pump 31 that has impeller 86 as a first pressure-feeding mechanism portion capable of pressure-feeding the coolant, and delivers the coolant from machine-side coolant tank 21 using impeller 86; second pump 32 that has impeller 86 as a second pressure-feeding mechanism portion capable of pressure-feeding the coolant and screw 87 immersed in the coolant stored in machine-side coolant tank 21, and delivers the coolant from machine-side coolant tank 21 using impeller 86 and screw 87; first flow path 41 through which the coolant from first pump 31 flows; second flow path 42 through which the coolant from second pump 32 flows; and first foreign matter capturing unit 51 that has filtration filter 52, captures a foreign matter contained in the coolant using filtration filter 52, and is provided on a route of first flow path 41, of first flow path 41 and second flow path 42.

In coolant supply device 100 according to the first embodiment of the present invention configured as described above, by providing first foreign matter capturing unit 51 on the route of first flow path 41, of first flow path 41 through which the coolant containing a relatively small amount of the foreign matter flows and second flow path 42 through which a relatively large amount of the foreign matter flows, the timing of clogging of filtration filter 52 can be delayed. As a result, a burden of maintenance of first foreign matter capturing unit 51 can be kept small.

Although each of the first pump and the second pump according to the present invention includes the impeller as the pressure-feeding mechanism portion for pressure-feeding the coolant in the above description of the present embodiment, the present invention is not limited thereto. For example, each of the first pump and the second pump may be a type of pump that pressure-feeds the coolant using a rotating gear, or may be a type of pump that pressure-feeds the coolant using a reciprocating piston.

### Second Embodiment

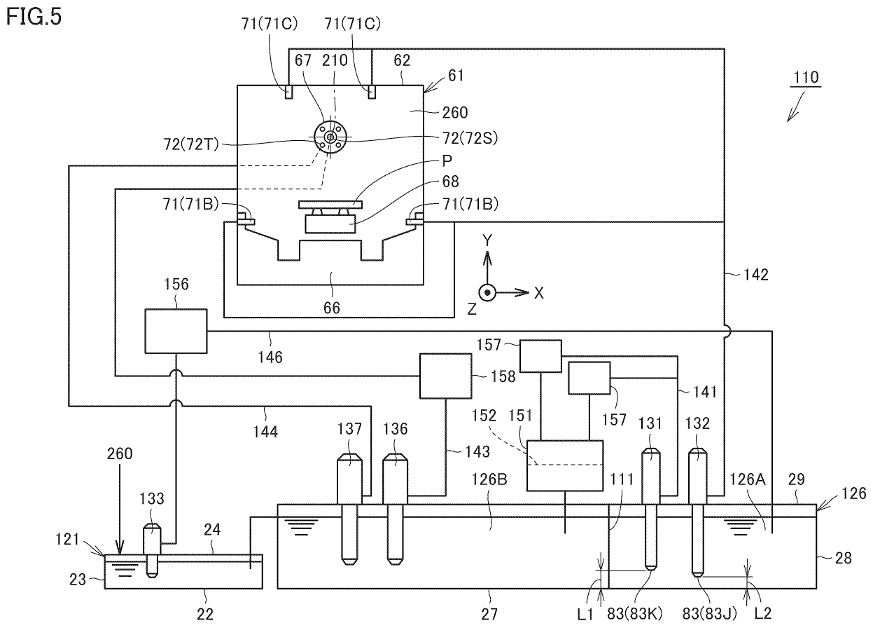

FIG. 5 is a system diagram showing a coolant treatment device according to a second embodiment of the present invention. A coolant supply device 110 according to the present embodiment has basically the same structure, as compared with coolant supply device 100 according to the first embodiment. Hereinafter, description of the same structure will not be repeated.

Referring to FIG. 5, coolant supply device 110 according to the present embodiment has a machine-side coolant tank 121 and a separately placed coolant tank 126. Machine-side coolant tank 121 and separately placed coolant tank 126 correspond to machine-side coolant tank 21 and separately placed coolant tank 26 according to the first embodiment, respectively.

Separately placed coolant tank 126 has a partition wall portion 111. Partition wall portion 111 rises upward from bottom portion 27 of separately placed coolant tank 126. Partition wall portion 111 partitions the inside of separately placed coolant tank 126 into a first storage space 126A and a second storage space 126B.

Coolant supply device 110 further has a first pump 131, a first flow path 141, a second pump 132, a second flow path 142, a first foreign matter capturing unit 151, and a fourth foreign matter capturing unit 157.

First pump 131 has the same structure as that of first pump 31 shown in FIGS. 2 and 3. First pump 131 is provided in first storage space 126A of separately placed coolant tank 126. First pump 131 delivers a coolant from separately placed coolant tank 126 (first storage space 126A).

The coolant from first pump 131 flows through first flow path 141. First flow path 141 extends between first storage space 126A and second storage space 126B of separately placed coolant tank 126. When first pump 31 is driven, a coolant flow from first storage space 126A through first flow path 141 to second storage space 126B is formed.

Second pump 132 has the same structure as that of second pump 32 shown in FIG. 4. Second pump 132 is provided in first storage space 126A of separately placed coolant tank 126. Second pump 132 delivers the coolant from separately placed coolant tank 126 (first storage space 126A).

The coolant from second pump 132 flows through second flow path 142. Second flow path 142 extends between first storage space 126A of separately placed coolant tank 126 and first coolant discharge portion 71 (base coolant discharge portion 71B and shower coolant discharge portion 71C).

First foreign matter capturing unit 151 has the same structure as that of first foreign matter capturing unit 51 according to the first embodiment. First foreign matter capturing unit 151 has a filtration filter 152. Fourth foreign matter capturing unit 157 has the same structure as that of fourth foreign matter capturing unit 57 according to the first embodiment. First foreign matter capturing unit 151 and fourth foreign matter capturing unit 157 are provided on the route of first flow path 141. Fourth foreign matter capturing unit 157 is provided more upstream of the coolant flow formed in first flow path 141 than first foreign matter capturing unit 151.

Coolant supply device 110 further has a spindle-through pump 136, a spindle pump 137, a spindle-through flow path 143, and a spindle flow path 144.

Spindle-through pump 136 and spindle pump 137 correspond to spindle-through pump 36 and spindle pump 37 according to the first embodiment, respectively. Spindle-through pump 136 and spindle pump 137 are provided in second storage space 126B of separately placed coolant tank 126. Spindle-through pump 136 and spindle pump 137 deliver the coolant from second storage space 126B of separately placed coolant tank 126.

Spindle-through flow path 143 and spindle flow path 144 correspond to spindle-through flow path 43 and spindle flow path 44 according to the first embodiment, respectively. When spindle-through pump 136 is driven, a coolant flow from second storage space 126B of separately placed coolant tank 126 through spindle-through flow path 143 and tool spindle 67 to spindle-through coolant discharge portion 72S is formed. When spindle pump 137 is driven, a coolant flow from second storage space 126B of separately placed coolant tank 126 through spindle flow path 144 and tool spindle 67 to spindle coolant discharge portion 72T is formed.

An inline-type pump 158 that delivers the coolant toward spindle-through coolant discharge portion 72S is further provided on a route of spindle-through flow path 143.

Coolant supply device 110 further has a third pump 133, a third flow path 146 and a third foreign matter capturing unit 156.

Third pump 133 is provided in machine-side coolant tank 121. Third pump 133 is attached to top portion 24 of machine-side coolant tank 121. Third pump 133 is an immersion-type pump. Third pump 133 delivers the coolant from machine-side coolant tank 121. In the present embodiment, machine-side coolant tank 121 corresponds to the second coolant tank according to the present invention.

Third flow path 146 is a passage through which the coolant flows, and is formed of a pipe member such as a steel pipe or a hose. The coolant from third pump 133 flows through third flow path 146. Third flow path 146 extends between third pump 133 and first storage space 126A of separately placed coolant tank 126. When third pump 133 is driven, a coolant flow from machine-side coolant tank 121 through third flow path 146 to first storage space 126A of separately placed coolant tank 126 is formed.

Third foreign matter capturing unit 156 is provided on a route of third flow path 146. Third foreign matter capturing unit 156 is provided more downstream of the coolant flow formed in third flow path 146 than third pump 133.

Third foreign matter capturing unit 156 captures a foreign matter such as chips or sludge contained in the coolant flowing through third flow path 146. Third foreign matter capturing unit 156 is a filterless-type foreign matter capturing unit that does not have a filtration filter. Third foreign matter capturing unit 156 is a centrifugal separator that captures a foreign matter using the centrifugal force.

With such a configuration, when third pump 133 is driven, the foreign matter is collected from machine-side coolant tank 21 to third pump 133 and is captured by third foreign matter capturing unit 156 provided on the route of third flow path 146, and then, the coolant from which the foreign matter has been removed is supplied to first storage space 126A of separately placed coolant tank 126. In addition, when first pump 131 is driven, the finer foreign matter is collected from first storage space 126A to first pump 131 and is captured by fourth foreign matter capturing unit 157 and first foreign matter capturing unit 151 provided on the route of first flow path 141, and then, the coolant from which the foreign matter has been removed is supplied to second storage space 126B of separately placed coolant tank 126.

In this case, the coolant delivered by first pump 131 and flowing through first flow path 141 contains only a small amount of the foreign matter, and thus, the timing of clogging of filtration filter 152 can be delayed. As a result, a burden of maintenance of first foreign matter capturing unit 151 can be kept small.

The coolant stored in second storage space 126B is supplied to second coolant discharge portion 72 (spindle-through coolant discharge portion 72S and spindle coolant discharge portion 72T) through spindle-through flow path 143 and spindle flow path 144. As a result, the clean coolant is supplied to the machining point of the workpiece, and thus, a decrease in workpiece machining accuracy caused by the presence of the foreign matter at the machining point of the workpiece can be prevented.

In addition, when second pump 132 is driven, the coolant stored in first storage space 126A of separately placed coolant tank 126 is supplied to first coolant discharge portion 71 (base coolant discharge portion 71B and shower coolant discharge portion 71C) through second flow path 142. In this case, even when the coolant delivered by second pump 132 and flowing through second flow path 142 contains a large amount of the foreign matter, chip discharge by first coolant discharge portion 71 is not affected.

The structure of coolant supply device 110 according to the second embodiment of the present invention as described above will be summarized. Coolant supply device 110 according to the present embodiment includes: separately placed coolant tank 126 as a first coolant tank that stores a coolant; first pump 131 that has impeller 86 as a first pressure-feeding mechanism portion capable of pressure-feeding the coolant, and delivers the coolant from separately placed coolant tank 126 using impeller 86; second pump 132 that has impeller 86 as a second pressure-feeding mechanism portion capable of pressure-feeding the coolant and screw 87 immersed in the coolant stored in separately placed coolant tank 126, and delivers the coolant from separately placed coolant tank 126 using impeller 86 and screw 87; first flow path 141 through which the coolant from first pump 131 flows; second flow path 142 through which the coolant from second pump 132 flows; and first foreign matter capturing unit 151 that has filtration filter 152, captures a foreign matter contained in the coolant using filtration filter 152, and is provided on a route of first flow path 141, of first flow path 141 and second flow path 142.

Coolant supply device 110 according to the second embodiment of the present invention configured as described above can provide the same effect as that of coolant supply device 100 according to the first embodiment.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### Industrial Applicability

The present invention is, for example, used in a coolant supply device applied to a machine tool such as a machining center.

### Reference Signs List

machine tool; 21, 121 machine-side coolant tank; 22, 27 bottom portion; 23, 28 side portion; 24, 29 top portion; 26, 126 separately placed coolant tank; 31, 131 first pump; 32, 132 second pump; 36, 136 spindle-through pump; 37, 137 spindle pump; 38, 138 shower/base pump; 41, 141 first flow path; 42, 142 second flow path; 43, 143 spindle-through flow path; 44, 144 spindle flow path; 45 shower/base flow path; 51, 151 first foreign matter capturing unit; 52, 152 filtration filter; 56 second foreign matter capturing unit; 57, 157 fourth foreign matter capturing unit; 58, 158 pump; 61 cover body; 62 ceiling portion; 66 bed; 67 tool spindle; 68 table; 71 first coolant discharge portion; 71B base coolant discharge portion; 71C shower coolant discharge portion; 72 second coolant discharge portion; 72S spindle-through coolant discharge portion; 72T spindle coolant discharge portion; 80 motor portion; 81 pump portion; 82 housing; 82p enlarged-diameter portion; 82q reduced-diameter portion; 83 suction portion; 83J second suction portion; 83K first suction portion; 84 discharge portion; 85 shaft; 86 impeller; 87 screw; 88 bearing; 91 disc portion; 91a disc surface; 92 first vane portion; 96 shaft portion; 97 second vane portion; 100, 110 coolant supply device; 111 partition wall portion; 126A first storage space; 126B second storage space; 133 third pump; 146 third flow path; 156 third foreign matter capturing unit; 210 rotation central axis; 220 central axis; 260 machining area.

1. A coolant supply device comprising:
a first coolant tank that stores a coolant;
a first pump that has a first pressure-feeding mechanism portion capable of pressure-feeding the coolant, and delivers the coolant from the first coolant tank using the first pressure-feeding mechanism portion;
a second pump that has a second pressure-feeding mechanism portion capable of pressure-feeding the coolant and a screw immersed in the coolant stored in the first coolant tank, and delivers the coolant from the first coolant tank using the second pressure-feeding mechanism portion and the screw;
a first flow path through which the coolant from the first pump flows;
a second flow path through which the coolant from the second pump flows; and
a first foreign matter capturing unit that has a filtration filter, captures a foreign matter contained in the coolant using the filtration filter, and is provided on a route of the first flow path, of the first flow path and the second flow path, wherein
the coolant having passed through the first foreign matter capturing unit flows directly through the first coolant tank or a separately placed coolant tank without passing through a machining area of a machine tool.

2. The coolant supply device according to claim 1, further comprising
a second foreign matter capturing unit that is of filterless type, captures the foreign matter contained in the coolant, and is provided on a route of the second flow path.

3. The coolant supply device according to claim 2, wherein
the second foreign matter capturing unit is a magnet separator that captures the foreign matter using magnetic force, or a cyclone separator or a centrifugal separator that captures the foreign matter using centrifugal force.

4. The coolant supply device according to claim 2, wherein
the second flow path forms a circulation path for the coolant starting from the first coolant tank.

5. The coolant supply device according to claim 1, further comprising
a first coolant discharge portion that is supplied with the coolant through the second flow path, and discharges the coolant to avoid a machining point of a workpiece in the machining area.

6. The coolant supply device according to claim 5, further comprising:
a second coolant tank that stores the coolant discharged from inside the machining area;
a third pump that delivers the coolant from the second coolant tank;
a third flow path through which the coolant from the third pump flows, the third flow path returning the coolant to the first coolant tank; and
a third foreign matter capturing unit that captures the foreign matter contained in the coolant, and is provided on a route of the third flow path.

7. The coolant supply device according to claim 1, further comprising
a second coolant discharge portion that is supplied with the coolant through the first flow path, and discharges the coolant toward a machining point of a workpiece in the machining area.

8. The coolant supply device according to claim 1, wherein
the first pump has a first suction portion that is immersed in the coolant stored in the first coolant tank, and suctions the coolant,
the second pump has a second suction portion that is immersed in the coolant stored in the first coolant tank, and suctions the coolant, and
a distance from a bottom portion of the first coolant tank to the first suction portion is greater than a distance from the bottom portion of the first coolant tank to the second suction portion.
